(19) United States
(12) Patent Application Publication
(10) Pub. No.: US 2002/0073312 A1
(43) Pub. Date: Jun. 13, 2002

(54) Secure electronic software distribution

(75) Inventors: Cynthia Ann Adiano, Bryan, TX (US); Jonathan James Hurd, Lexington, KY (US); Michael Todd Knight, Lexington, KY (US)

Correspondence Address: Edward H. Duffield, IBM Corporation T81B/B503, P.O. Box 12195, Research Triangle Park,, NC, 27709, US

(73) Assignee: International Business Machines Corporation, Armonk, NY (US)

(21) Appl. No.: 09/733,737

(22) Filed: Dec. 8, 2000

(51) Int. Cl. H04L 9/00

(52) U.S. Cl. 713/165

(57) ABSTRACT

Secure software distribution is initiated by sending software media files to a recipient machine as an attachment to an electronic mail message. The software media files include an installation script that copies the program files and creates the icons necessary to run the application. The recipient opens the electronic mail message in his mail folder and clicks on an installation button to activate execution of the installation script. After successful completion of the installation the script is marked “used” and cannot be used again. Marking of the installation script as “used” also disables the forwarding mechanism of the electronic mail software to prevent the user from accessing a second copy of the software. When the recipient saves the electronic mail message, the “used” flag is set and the script can continue. The installation script stores the encrypted hard drive serial number into the system registry. When the application is launched, the hard drive serial number is read from the installation machine and compared to the value stored in the system registry. If the serial numbers match, the application is allowed to execute normally. If they do not match, the application terminates. This prevents the application from being used even if the entire hard drive image is copied to another machine.

### BACKGROUND OF THE INVENTION

The present invention relates to methods and apparatus for distribution of software electronically.

Software that is distributed via CD-ROM, diskettes, or a communications network can easily be copied without the permission of the software developer or copyright owner. For software that is distributed by CD-ROM, some have attempted to solve this problem by requiring a key to be entered when the software is installed. This approach does not stop a user from installing the software on another machine once he has access to the key. Often, software license agreements are displayed to the user and must be “agreed to” before the installation will continue. This also does not protect the software developer and copyright owner from theft of the intellectual property.

Electronic mail, or email, is probably the most heavily used feature of the Internet. It can be used to send messages to anyone who is connected to the Internet or connected to a computer network that has a connection to the Internet, such as an online service provider. Email messages are sent in the same way as most Internet data. The Transport Control Protocol (TCP) breaks the messages into packets, the Internet Protocol (IP) delivers the packets to the proper location, and then the TCP protocol reassembles the messages on the receiving end so that it can be read. Binary files can also be attached to email messages. These include documents, graphics, videos, sounds, and executable files. Since the Internet is not able to directly handle binary files in email, the file must first be encoded in one of a variety of encoding schemes. The recipient of the attached binary file (attachment) must decode the file with the same scheme that was used to encode the file. Many email software packages do this automatically. When email is sent to a recipient over the Internet, the message has to travel through a series of networks before it reaches the recipient. These networks can use different email formats. Gateways perform the job of translating email formats from one network to another so that the messages can make their way through all the networks of the Internet. An email message is made up of binary data, usually in the ASCII text format. ASCII is a standard that enables any computer to read the text, regardless of its operating system or hardware. ASCII code describes the characters that are seen on a user's computer screen.

After the Internet delivers mail to the recipient, the recipient needs a way to read the mail, to compose new mail, and to respond to messages. This is done using email software, sometimes called mailers or readers. An email message sent to a recipient usually isn't delivered directly to his computer. Instead, it gets sent to a mail server. The recipient's email software logs onto the mail server and checks to see whether the recipient has any mail. If the recipient has new mail, he will see a list of his new mail messages when he logs into the mail server. Typically, the list will include the name of the sender, the subject of the message, and the date and time that the message was sent. When the recipient wants to read a mail message, the email software downloads the message to the recipient's computer. The recipient reads the message by using his mail reader, and then can file it, delete it, or respond to it. Email software typically enables a user to do such things as create folders for storing mail, search through messages, keep an address book of people to whom the user has sent mail, create group mailing lists, create and add a signature file, etc.

### SUMMARY OF THE INVENTION

This invention is for an electronic distribution system that protects software developers and copyright owners by allowing software to be installed on only one machine. The invention takes advantage of a low cost groupware-based delivery mechanism such as the Lotus Notes e-mail product available from Lotus Corporation. This mechanism keeps track of the installation status of the media and securely marks it “used” after successful installation of the product. This prevents theft of the underlying intellectual property.

Secure software distribution starts by sending the software media files to a recipient computer as an attachment to an electronic mail message. The software media files include an installation script that copies the program files and creates the icons necessary to run the application. The recipient opens the electronic mail message in his mail folder and clicks on an installation button to activate execution of the installation script. After successful completion of the installation the script is marked “used” and cannot be used again. Marking of the installation script as “used” also disables the forwarding mechanism of the electronic mail software to prevent the user from accessing a second copy of the software. When the recipient saves the electronic mail, the “used” flag is set and the script can continue. The installation script stores the encrypted hard drive serial number into the system registry. When the application is launched, the hard drive serial number is read from the installation machine (i.e., personal computer, laptop) and compared to the value stored in the system registry. If the serial numbers match, the application is allowed to execute normally. If they do not match, the application terminates. This prevents the application from being used even if the entire hard drive image is copied to another machine.

### BRIEF DESCRIPTION OF THE DRAWINGS

The invention is better understood by reading the following detailed description of the invention in conjunction with the accompanying drawings wherein:

FIG. 1 illustrates an overview of the secure electronic software distribution system in accordance with an exemplary embodiment of the present invention.

FIG. 2 illustrates a screen display of an electronic mail message with the user installation package attached in accordance with an exemplary embodiment of the present invention.

FIG. 3 illustrates a screen display containing notes to users regarding installation steps in accordance with an exemplary embodiment of the present invention.

FIG. 4 illustrates a screen display that is presented to the user if he is not running a mail database from the mail server in accordance with an exemplary embodiment of the present invention.

FIG. 5 illustrates a screen display of a message to a user that installation of the package has been completed in accordance with an exemplary embodiment of the present invention.

FIG. 6 illustrates a screen display presented to the user to finalize installation of the software package in accordance with an exemplary embodiment of the present invention.

FIG. 7 illustrates a screen display presented to the user to indicate that the software has been successfully installed in accordance with an exemplary embodiment of the present invention.

FIG. 8 illustrates a screen display of an updated electronic mail message presented to the user to indicate that the installation of the software package has been completed.

FIG. 9 illustrates the processing logic for installation of software media files in accordance with an exemplary embodiment of the present invention.

FIG. 10 illustrates the processing logic for enabling a software application after successful installation in accordance with an exemplary embodiment of the present invention.

### DETAILED DESCRIPTION OF THE INVENTION

The present invention for a secure electronic software distribution system and method is described in the context of a Lotus Notes groupware product including electronic mail capability. Although some of the concepts relied upon for description purposes are taken from Lotus Notes, the present invention is equally applicable to any other groupware/email product, including Outlook from Microsoft Corporation and GroupWise from Novell Corporation.

Lotus Notes is based on client/server technology which enables a user to access, share and manage information over a network. The user's personal computer or laptop is the Lotus Notes client. It requests and receives information from the Domino server.

Information requested by the user is contained in Lotus Notes applications, or databases. The Domino server usually stores these databases so that many users can access them simultaneously. In most cases, when the user clicks a database bookmark, he is actually opening a database that is stored on a server. The Lotus Notes client requests that database from the server, and when the database opens, the database that resides on a server appears. The user's mail is contained in a mail database. When a user opens a database, Notes displays the contents of the database in a list, called a view. Each line in a database represents one document. Databases often contain more than one view or more than one way of listing information.

From the mail database, the user can send, receive, forward, delete, read and answer messages. Some databases are local databases that are stored on the hard drive of the user's computer. These databases are available to the user whenever he needs them, regardless of whether or not he is connected to the Domino server. Other databases are stored on the Domino server. This enables the user and others in the organization to access information centrally and share it. When the user is working on a server database, the changes he makes are immediately seen by anyone else who is also accessing that database.

For a mobile user, the local databases may contain replicas of the databases on the server. A replica is a specialized form of copy that maintains a link back to the original database on the server. When the user makes changes to his local replica of the database, he is working on his computer with a database that is saved on his hard drive. However, at some point, the changes made to the database are transmitted to the server, and the modifications to the server version of the database are transmitted back to the replica. This process is called replication. When the user replicates, the computer and server only exchange the modified or new database documents, not the entire database file.

The Mail Navigation Pane in Lotus Notes list views, such as the Inbox, Drafts and Sent views, and Folders that are created by the user to organize his mail messages. The user clicks on the Inbox view to see his incoming mail messages. The user can see who sent the message, the date it was sent, and the size and subject of the message. All unread messages have a red star in a selection bar to the left of the message.

In Lotus Notes, attachments can be placed only in rich text fields, and the body of the mail message is the only rich text field in the mail message form. The attachment can be a database, a spread sheet, an executable file, a word processing document, a compressed file, a graphics file, or a scanned photograph among several possibilities. Once a file is attached within the rich text field of the mail message, it can be sent to an intended recipient. The file that is attached is a copy, so that the original remains intact on the sender's computer.

Secure software distribution starts by creating an installation script that writes an encrypted key, including the hard drive serial number, into the system registry of an end-user's machine. The installation script is made available to the user who has purchased the software via a “Lotus Notes” note or a “Lotus Notes” database link. The required Lotus Notes ID is an additional control measure to prevent unauthorized access to the installation media. When the user clicks on the install button, the below described events occur.

The first event is the installation of the software files. The script copies the program files and creates the icons necessary to run the application, but at this point the application is still not enabled.

The second event is the disabling of subsequent installations. After successful completion of the installation, the script is marked “used” and cannot be used again. If the delivery is based on a Lotus Note, the user is prompted to save the email. Forwarding is also disabled to prevent the user from accessing a second copy of the software. The system checks to make sure that the user is running from his primary mail server and not from a local replica. When the email is saved, the “used” flag is set and the script can continue. If the email is not saved, the installation is not complete and the application is not usable. If the installation is delivered via a database, a “used” flag is set preventing another installation for this user.

The final event is enabling the application. The installation script stores the encrypted hard drive serial number in the system registry. When the application is launched, the hard drive serial number is read from the machine and compared to the value stored in the system registry. If the serial numbers match, the application is allowed to start normally. If the numbers do not match, the application terminates. This prevents using the application, even if the entire hard drive image is copied to another machine.

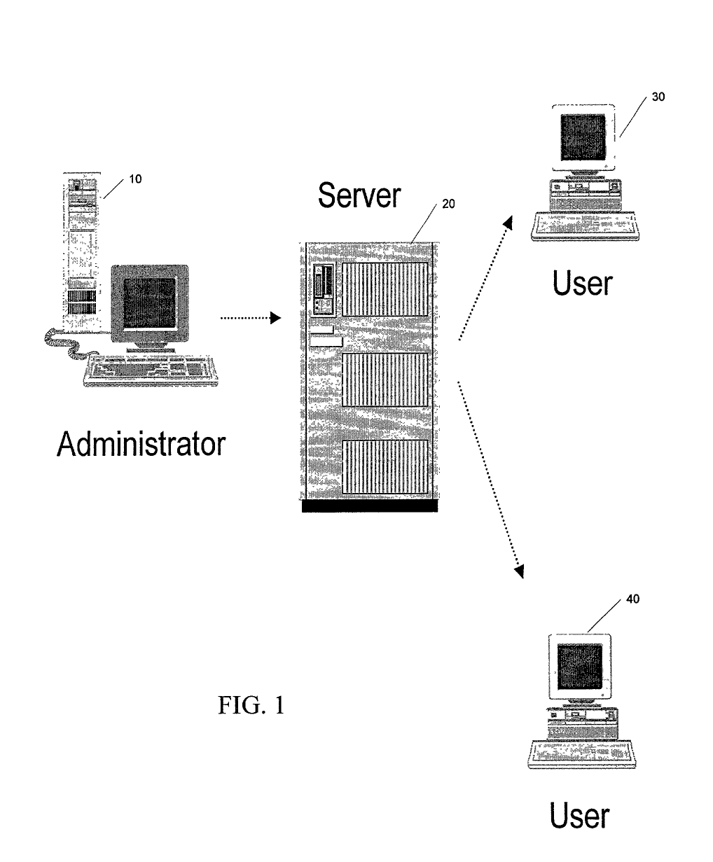

FIG. 1 illustrates an overview of the secure electronic software distribution system. An administrator 10 sends a packaged security logic and application installation files via a server 20 to one or more application users 30, 40. The user 30, 40 receives and executes the installation package. The security logic marks the received media as used and enables the application.

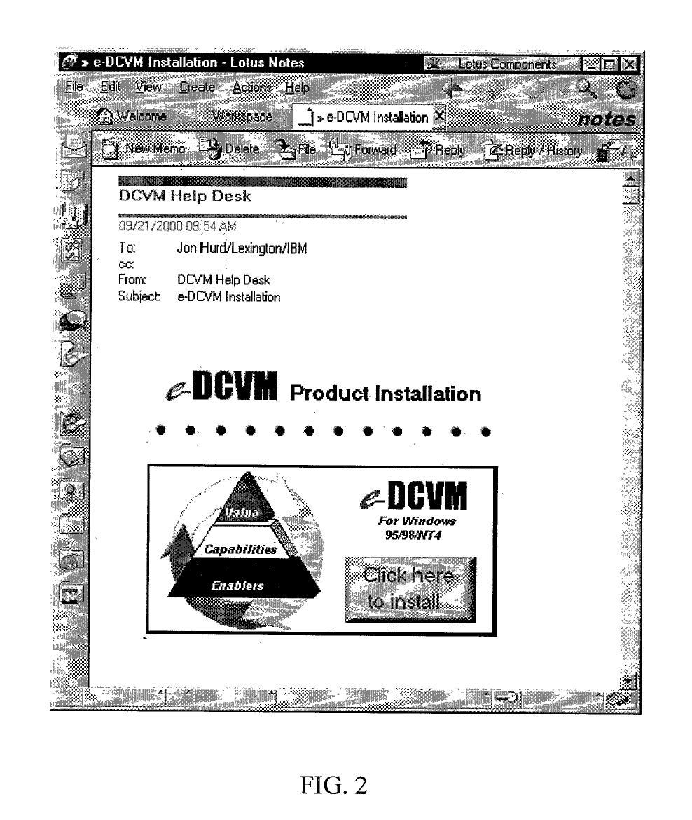

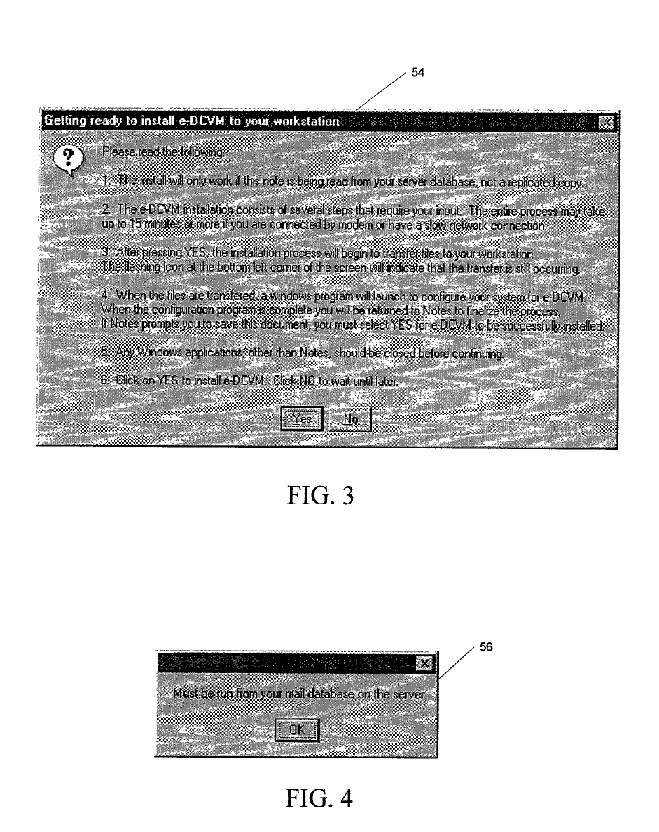

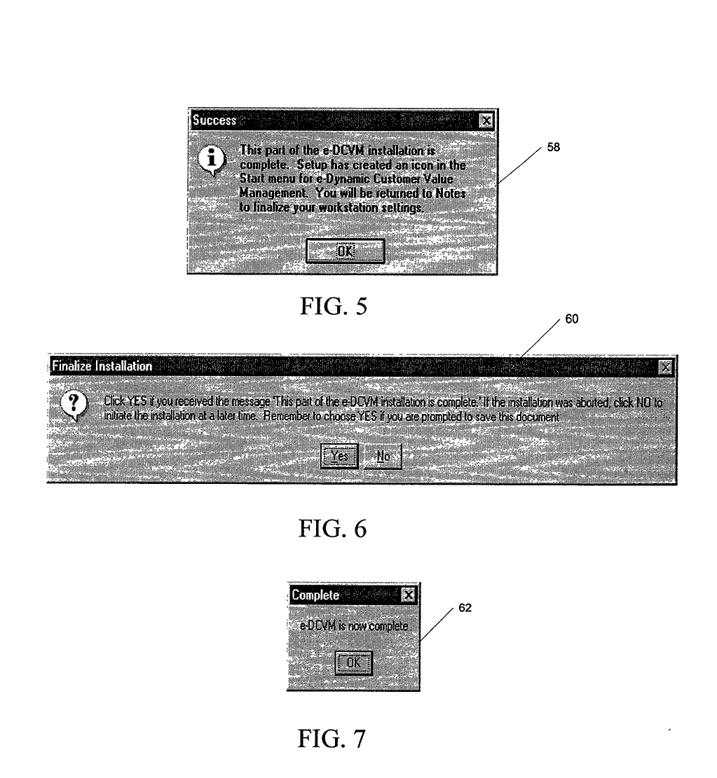

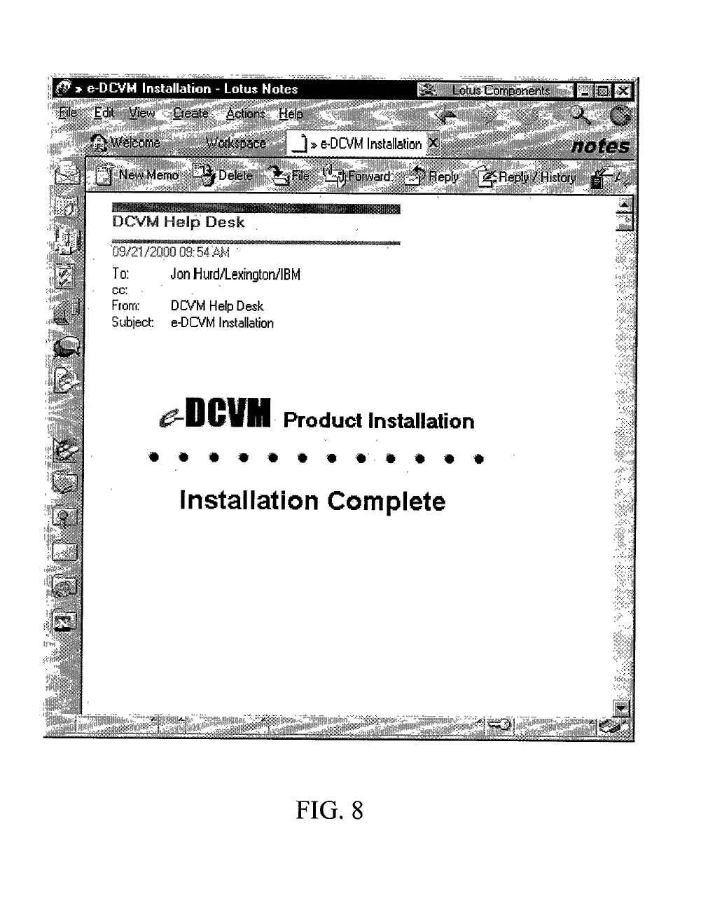

FIG. 2 illustrates an exemplary email screen 50 containing an attachment for installation of a software package by an end user. The lower part of the screen 50 contains the attachment 52 that the user clicks to install the software package. Before installation can proceed, the user is presented with the screen display 54 depicted in FIG. 3. Of particular note is item one which informs the user that the installation will only work if the email containing the attachment is being read from his server database, and not from a replicated copy. By clicking on the yes button, the installation process starts transfer of files to the user's workstation. If the user attempts to install the application from a replicated copy of his mail database, then the warning message 56 illustrated in FIG. 4 is displayed. This reinforces to the user that the installation process can only be run from the mail database on the server. When the installation is complete, a message is provided to the user that the software has been successfully installed. The user is then presented with the message 58 depicted in FIG. 5. The package still needs to be marked as used. In FIG. 6 the user is presented with a message 60 that prompts him to save this document. Upon clicking yes, the user is presented with the message 62 that the installation is now complete, as indicated in FIG. 7. Finally, the user is presented with the display shown in FIG. 8 that marks the package as used (not visible to the user).

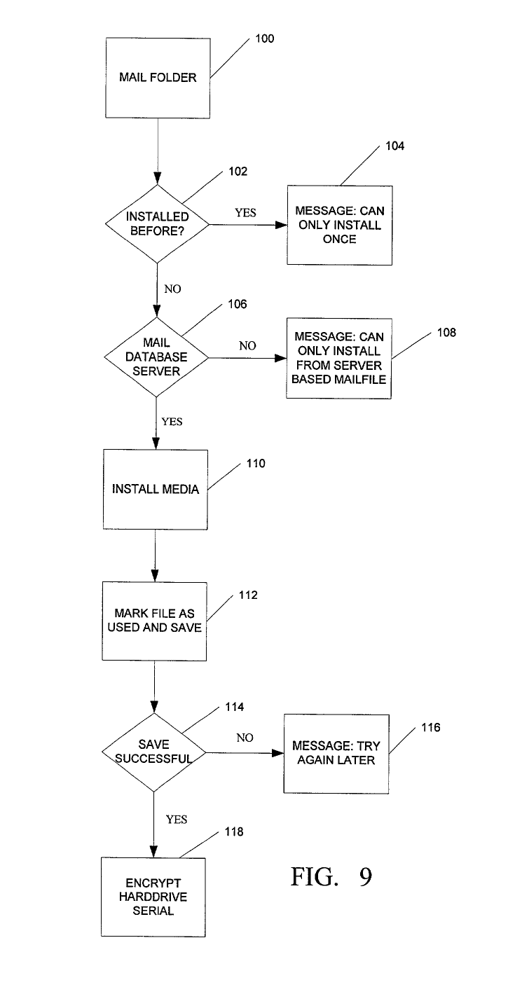

FIG. 9 illustrates the processing logic for installation of software files. Processing begins in logic block 100 in which the installation file is present as an attachment to an email message. In decision block 102, a test is made to determine if installation has been completed previously. If it has been, as indicated in logic block 104, a message is displayed to a user that the software can only be installed once. If the software has not been previously installed, then in decision block 106 a test is made to determine if the mail database is on the server. If it is not, then as indicated in logic block 108, the user is provided with a message that the software can only be installed from a server-based mail file. If it is determined in decision block 106 that the mail database is on the server, then the media is installed as indicated in logic block 110. The files are then marked as “used” and saved as indicated in logic block 112. This is followed in decision block 114 with a test to determine if the save was successful or not. If it was not successful, then the user is presented with a message to try the installation at a later time, as indicated in logic block 116. If the save is successful, then, as indicated in logic block 118, the hard drive serial is encrypted in the system registry.

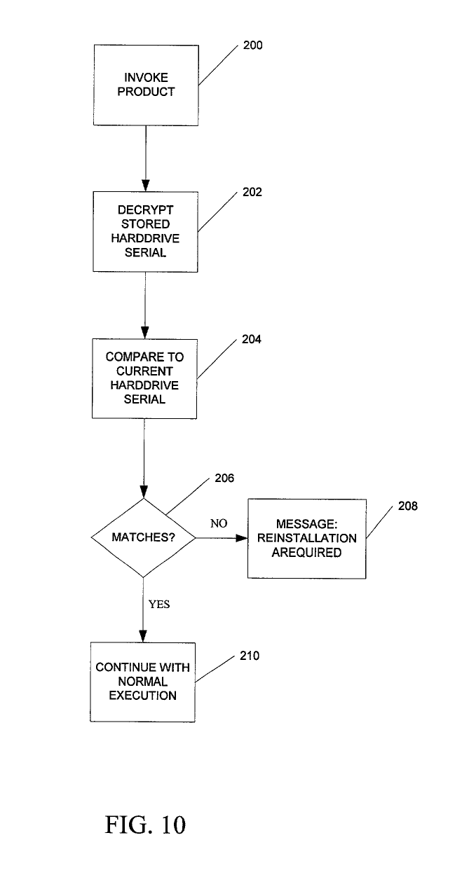

FIG. 10 illustrates the processing logic for enabling a software application. The processing commences in logic block 200 with an invocation of the product. As indicated in logic block 202, the stored hard drive serial number is decrypted. This is followed in logic block 204 by comparing the decrypted serial number to the current hard drive serial number. If the decrypted serial number matches the current hard drive serial number in decision block 206, then processing continues with normal execution of the application, as indicated in logic block 210. If the decrypted hard drive serial number does not match the current hard drive serial number, the user is presented with a message indicating that reinstallation is required, as indicated in logic block 208.

Although the present invention has been described in the context of secure electronic software distribution over a communications network, the inventive concepts are also applicable to software that is contained on other media such as a CD-ROM or a diskette. In this instance, the physical media are provided to the recipient for installation on his personal computer or laptop. However, in order to install the software application contained in the physical media, an electronic mail message must still be sent to the recipient in order to provide him with an attached installation file script that when operated in conjunction with the loading of the physical media will cause the media files to be installed on the hard drive of the personal computer or laptop.

The secure electronic software distribution mechanism of the present invention has been described as a software program resident on a CD-ROM, a diskette, or a server from which it is accessible over a public, non-trusted network such as the Internet, or over an organization's intranet. It is important to know, however, that those skilled in the art will appreciate that the mechanisms of the present invention are capable of being distributed with a program product in a variety of forms, and that the present invention applies regardless of the particular type of signal bearing media utilized to carry out the distribution. Examples of signal bearing media include, without limitation, recordable type media such as diskettes or CD-ROMs, and transmission type media such as analog or digital communications links.

Computer program instructions or computer programs in the present context means any expression, in any language, code or notation, or a set or instructions intended to cause a system having an information processing capability to perform a particular function, either directly or when either or both of the following occur: (a) conversion to another language, code or notation; (b) reproduction in a different material form.

Additionally, the corresponding structures, materials, acts, and equivalents of all means plus function elements in any claims are intended to include any structure, material or acts for performing the function in combination with other claimed elements as specifically claimed.

While the invention has been particularly shown and described with reference to a preferred embodiment thereof, it will be understood by those skilled in the art that various changes in form and detail without departing from the spirit and scope of the present invention.

What is claimed:

1. A method for the secure electronic distribution of software media files using an electronic mail application as a delivery mechanism, comprising the acts of:
sending the software media files to a recipient computer by appending the media files as an attachment to an electronic mail message;
opening the electronic mail message in the mail folder of the recipient;
installing the attached media files on a storage component of the recipient computer; and
marking the media files as used and saved to disable a subsequent installation.

2. The method for the secure electronic distribution of software media files of claim 1 further comprising the act of determining if the software media files have been installed previously.

3. The method for the secure electronic distribution of software media files of claim 2 further comprising providing a message to the recipient that the software media files can only be installed one time if the software media files have been previously installed.

4. The method for the secure electronic distribution of software media files of claim 1 further comprising the act of determining if the mail database is on a mail server for the recipient.

5. The method for the secure electronic distribution of software media files of claim 1 further comprising the act of determining if the saving of the software media files is successful.

6. The method for the secure electronic distribution of software media files of claim 5 further comprising providing a message to the recipient that the installation has not been successfully completed.

7. The method for the secure electronic distribution of software media files of claim 5 further comprising the encryption of a serial number of the storage component into a system registry of the recipient's computer.

8. A method for enabling an application distributed as secure electronic software media files attached to an electronic mail message, comprising the acts of:
invoking the application from a storage component on a recipient computer;
decrypting a serial number of the storage component that has been encrypted and saved in the system registry of the recipient computer;
comparing the decrypted serial number to a serial number for the storage component of the recipient computer;
enabling execution of a plurality of instructions contained in the application if the decrypted serial number matches the storage component serial number.

9. The method for enabling an application distributed as secure electronic software media files of claim 8 further comprising the act of providing a message to the recipient that reinstallation of the software media files is required if the decrypted serial number does not match the storage component serial number.

10. The method for enabling an application distributed as secure electronic software media files of claim 8 further comprising the act of terminating the application if the decrypted serial number does not match the storage component serial number.

11. A computer readable medium containing a computer program product for the secure electronic distribution of software media files using an electronic mail application as a delivery mechanism, the computer program product comprising:
program instructions that receive the software media files on a recipient computer wherein the media files are appended as an attachment to an electronic mail message;
program instructions that open the electronic mail message in the mail folder of the recipient;
program instructions that install the attached media files on a storage component of the recipient computer; and
program instructions that mark the media files as used and saved to disable a subsequent installation.

12. The computer program product for the secure electronic distribution of software media files of claim 11 further comprising the program instructions that determine if the software media files have been installed previously.

13. The computer program product for the secure electronic distribution of software media files of claim 12 further comprising program instructions that provide a message to the recipient that the software media files can only be installed one time if the software media files have been previously installed.

14. The computer program product for the secure electronic distribution of software media files of claim 11 further comprising program instructions that determine if the mail database is on a mail server for the recipient.

15. The computer program product for the secure electronic distribution of software media files of claim 11 further comprising program instructions that determine if the saving of the software media files is successful.

16. The computer program product for the secure electronic distribution of software media files of claim 15 further comprising program instructions that provide a message to the recipient that the installation has not been successfully completed.

17. The computer program product for the secure electronic distribution of software media files of claim 15 further comprising program instructions that encrypt the serial number of the storage component into a system registry of the recipient's computer.

18. A computer readable medium containing a computer program product for enabling an application that is distributed as secure electronic software media files attached to an electronic mail message, the computer program product comprising:
program instructions that invoke the application from a storage component on a recipient computer;
program instructions that decrypt a serial number of the storage component that has been encrypted and saved in the system registry of the recipient computer;
program instructions that compare the decrypted serial number to a serial number for the storage component of the recipient computer;
program instructions that enable execution of a plurality of instructions contained in the application if the decrypted serial number matches the storage component serial number.

19. The computer program product for enabling an application distributed as secure electronic software media files of claim 18 further comprising program instructions that provide a message to the recipient that reinstallation of the software media files is required if the decrypted serial number does not match the storage component serial number.

20. The computer program product for enabling an application distributed as secure electronic software media files of claim 18 further comprising program instructions that terminate the application if the decrypted serial number does not match the storage component serial number.

21. A system for the secure electronic distribution of software media files over a communications network, comprising:
a sending component at a first network location that transmits software media files attached to an electronic mail message to a plurality of other network locations;
a mail server at a second network location including a component that receives and stores software media files attached to electronic mail messages in a mail database; and
a client device connected to the mail server to access electronic mail messages intended for the client device, the client device including a reader for opening the electronic mail message and a processor for executing program instructions in the attached media files that control installation of the media files on a storage component of the client device and that mark the media files as used and saved to disable a subsequent installation.

22. The system for the secure electronic distribution of software media files of claim 21 wherein the communications network is the Internet.

23. The system for the secure electronic distribution of software media files of claim 21 wherein the communications network is an intranet.

24. The system for the secure electronic distribution of software media files of claim 21 wherein the storage component on the client device is a computer hard drive.

25. The system for the secure electronic distribution of software media files of claim 21 wherein the processor executes program instructions in the media files that determine if the media files have been installed previously.

26. The system for the secure electronic distribution of software media files of claim 21 wherein the processor executes program instructions in the media files that determine if the mail database is on the mail server to which the client device is attached.

27. The system for the secure electronic distribution of software media files of claim 21 wherein the processor executes program instructions in the media files that determine if the media files have been stored successfully to the storage component.

28. The system for the secure electronic distribution of software media files of claim 21 wherein the processor executes program instructions in the media files that encrypt a serial number of the storage component and saves the encrypted serial number in a system registry of the client device.

29. The system for the secure electronic distribution of software media files of claim 28 wherein the processor executes program instructions in the media files for:
invoking an application included in the stored media files;
decrypting the serial number that has been saved in the system registry;
comparing the decrypted serial number with the serial number of the storage component; and
enabling execution of a plurality of instructions contained in the application if the decrypted serial number matches the storage component serial number.

30. The system for the secure electronic distribution of software media files of claim 29 wherein the processor executes program instructions in the media files that terminate the application if the decrypted serial number does not match the storage component serial number.

31. A client device for the secure electronic distribution of software media files comprising:
a software module for accessing electronic mail messages including attached media files that are received and stored by a mail server;
a storage component for storing media files attached to electronic mail messages that are accessed by the software module; and
a processor for executing program instructions in the media files that control installation of the media files on the storage component and that mark the media files as used and saved to disable a subsequent installation.

32. The client device for the secure electronic distribution of software media files of claim 31 wherein the processor executes program instructions in the media files that determine if the media files have been installed previously.

33. The client device for the secure electronic distribution of software media files of claim 31 wherein the processor executes program instructions in the media files that determine if the mail database is on the mail server that is accessed by the software module.

34. The client device for the secure electronic distribution of software media files of claim 31 wherein the processor executes program instructions in the media files that determine if the media files have been stored successfully to the storage component.

35. The client device for the secure electronic distribution of software media files of claim 31 wherein the processor executes program instructions in the media files that encrypt a serial number of the storage component and saves the encrypted serial number in a system registry of the client device.

36. The client device for the secure electronic distribution of software media files of claim 31 wherein the processor executes program instructions in the media files for:
invoking an application included in the stored media files;
decrypting the serial number that has been saved in the system registry;
comparing the decrypted serial number with the serial number of the storage component; and
enabling execution of a plurality of instructions contained in the application if the decrypted serial number matches the storage component serial number.

37. The client device for the secure electronic distribution of software media files of claim 36 wherein the processor executes program instructions in the media files that terminate the application if the decrypted serial number does not match the storage component serial number.

38. A client device for the secure distribution of software media files comprising:
a software module for accessing electronic mail messages including an installation script that is sent to the client device;
a storage component for storing software media files; and
a processor for executing program instructions in the installation script that control installation of the media files on a storage component and that marks the installation script as used to disable a subsequent installation of the software media files.

39. The client device for the secure distribution of software media files of claim 38 wherein the processor executes program instructions in the installation script that determine if the software media files have been installed previously.

40. The client device for the secure distribution of software media files of claim 38 wherein the processor executes program instructions in the installation script that determine if the software media files have been stored successfully to the storage component.

41. The client device for the secure distribution of software media files of claim 38 wherein the processor executes program instructions in the installation script that encrypt a serial number of the storage component and saves the encrypted serial number in a system registry of the client device.

42. The client device for the secure distribution of software media files of claim 38 wherein the processor executes program instructions in the installation script for:
invoking an application included in the software media files;
decrypting the serial number that has been saved in the system registry;
comparing the decrypted serial number with the serial number of the storage component; and
enabling execution of a plurality of instructions contained in the application if the decrypted serial number matches the storage component serial number.

43. The client device for the secure distribution of software media files of claim 42 wherein the processor executes program instructions in the installation script that terminate the application if the decrypted serial number does not match the storage component serial number.

44. The client device for the secure distribution of software media files of claim 38 wherein the software media files are distributed on a CD-ROM.

45. The client device for the secure distribution of software media files of claim 38 wherein the software media files are distributed on a diskette.
